(19) United States
(12) Patent Application Publication
(10) Pub. No.: US 2025/0289946 A1
(43) Pub. Date: Sep. 18, 2025

(54) PROCESS FOR PREPARING A POLYOLEFIN COMPOSITION

(71) Applicant: Basell Poliolefine Italia S.r.l, Milano (IT)

(72) Inventors: Marco Consalvi, Ferrara (IT); Luca Sgobino, Ferrara (IT)

(73) Assignee: Basell Poliolefine Italia S.r.l, Milano (IT)

(21) Appl. No.: 18/860,272

(22) PCT Filed: Apr. 19, 2023
(86) PCT No.: PCT/EP2023/060052

§ 371 Date: Oct. 25, 2024

(30) Foreign Application Priority Data
Apr. 26, 2022 (EP) 22170062.8

(51) Int. Cl. C08L 23/12; C08L 23/06

(52) U.S. Cl. CPC C08L 23/12; C08L 23/06

(57) ABSTRACT

A process for preparing a pelletized polyolefin composition made from or containing a virgin polyolefin and a recycled polyolefin material, carried out in a two-stage cascade extrusion process including feeding the recycled polyolefin material to the first stage extruder and the virgin polyolefin to the second stage extruder device, measuring the flow rate of the virgin material and the flow rate of the final composition, and adjusting the flow rate of the virgin polyolefin to meet the pre-set compositional target.

### FIELD OF THE INVENTION

In general, the present disclosure relates to the field of chemistry. More specifically, the present disclosure relates to polymer chemistry. In particular, the present disclosure relates to a process for preparing polyolefin compositions made from or containing recycled polyolefins and virgin polyolefins via extrusion blending.

### BACKGROUND OF THE INVENTION

Polyolefins are consumed for applications, including packaging for food and other goods, fibers, automotive components, and manufactured articles. The quantity of polyolefins raises concerns for the environmental impact of the waste materials generated after the first use of the polyolefins.

Waste plastic materials are coming from differential recovery of municipal plastic wastes (Post Consumer Resins). In some instances, municipal plastic waste includes flexible packaging (cast film, blown film, and BOPP film), rigid packaging, blow-molded bottles, and injection-molded containers. In some instances, through a step of sorting from other polymers, such as PVC, PET or PS, a recycled polyolefin stream is obtained for remolding purposes.

In some instances, the multicomponent nature of the recycled material results in low mechanical and optical performances. In some instances, the recycled polyolefin stream partially replaces virgin polymer in polyolefin formulations.

In some instances, the recycled material is blended with virgin polymers using compounding extrusion lines, thereby providing polymeric products with high level of properties.

In some instances, both recycled and virgin materials are used in pellets. In some cases, virgin material in pellets is added to recycled material in flakes during a compounding and filtration step.

In some instances, melt blending virgin and recycled material, both in pellet form, is costly and uses energy inefficiently because the recycled material and the virgin material are first processed by melt extrusion to form pellets using separate processes and then are melt blended, thereby producing the final compositions.

In some instances, melt blending of recycled flakes and virgin polymer is achieved in a single extrusion step. In some instances, it is difficult to ensure the correctness of the final production recipe.

In some instances and to overcome a deficiency of the single-extrusion-step process, the materials undergo a melt filtration step, thereby involving an overdesigned melt filter for handling the cumulative polymer flow. In some instances, the melt filter cleaning process results purging-to-scrap recycled material and virgin polymer.

In some instances, the recycled material is not free flowing, has a high content of humidity, or has a high level of contaminants, thereby undermining the stable and reliable feeding of the components. In some instances, part of the recycled material (humidity, contaminants, or both) does not separate at a constant rate or distribute homogeneously in the feed hopper with the virgin pellets, causing instability and inconsistency of feeding. As such and in some instances, the different polymers additives and reinforcing agents are inconsistent in the final recipe.

In some instances, the compounding processes are based on a two-stage extrusion process. In the first-stage extruder, recycled material is processed (including the steps of compacting, humidity and contaminants removal) into a molten stream. In the second-stage extrusion line, the molten stream is received and admixed with virgin polymer and reinforcing agents.

### SUMMARY OF THE INVENTION

In a general embodiment, the present disclosure provides a process for preparing a pelletized polyolefin composition made from or containing a virgin polyolefin and a recycled polyolefin material, having pre-set relative content, carried out in a two-stage cascade extrusion process, of which the second-stage extruder has a first feeding inlet and a second feeding inlet, and including the following steps:
(i) supplying the recycled polyolefin material to the first-stage extruder, thereby forming a molten recycled polyolefin material stream;
(ii) feeding the molten recycled polyolefin material stream to the second feeding inlet of the second- stage extruder, located after the first feeding inlet for receiving the virgin polyolefin;
(iii) feeding virgin polyolefin at a flow rate to the first feeding inlet of the second-stage extruder device, thereby forming a polyolefin composition, and extruding the polyolefin composition in a pelletized form;
(iv) measuring the flow rate of the virgin polyolefin supplied to the second stage extruder device and measuring the flow rate of the pellets of the final polyolefin composition obtained from the second extruder device;
   wherein a computing unit operation device, receiving data on measured flow of virgin polymer and measured flow rate of pelletized final polymer composition, adjusts the flow rate of the virgin polyolefin supplied to the second-stage extruder in response to the difference between the measured flow rate of the virgin polyolefin and the measured flow of pelletized final polymer composition, thereby producing a final pelletized polyolefin composition having the pre-set relative content of virgin polyolefin and recycled polyolefin material.

### BRIEF DESCRIPTION OF THE DRAWINGS

FIG. 1 shows a schematic of a two-stage cascade extrusion.

FIG. 2 shows a schematic of a two-stage cascade extrusion process, including peroxide dosing to the first-stage extruder.

### DETAILED DESCRIPTION OF INVENTION

While multiple embodiments are disclosed, other embodiments are within the following detailed description. Certain embodiments, as disclosed herein, are capable of modifications in various aspects, without departing from the spirit and scope of the claims as presented herein. Accordingly, the drawings and detailed description are illustrative in nature and not restrictive.

In some embodiments, the present disclosure provides polyolefin compositions made from or containing virgin polyolefins, recycled polyolefin material, and optionally one or more additives or reinforcing agents.

As used herein, the term “virgin” refers to newly-produced polyolefins prior to first use and not being recycled. In some embodiments, virgin polyolefin is derived from polymerization of olefins. In some embodiments, the olefins are selected from the group consisting of ethylene, propylene, butene-1, hexene-1, octene-1, and mixtures thereof.

In some embodiments, the olefinic polymers are selected from the group consisting of high density ethylene polymers (HDPE, having a density higher than 0.940 g/cc); linear low density polyethylene (LLDPE, having a density lower than 0.940 g/cc); very low density and ultra-low density (VLDPE and ULDPE, having a density lower than 0.920 g/cc, to 0.880 g/cc); isotactic polypropylenes and crystalline copolymers of propylene and ethylene and/or other alpha-olefins, having a content of units derived from propylene higher than 85% by weight, based upon the total weight of the copolymer; copolymers of propylene and 1-butene having a content of units derived from 1-butene between 1 and 40% by weight, based upon the total weight of the copolymer; and heterophasic copolymers made from or containing a crystalline polypropylene matrix and an amorphous phase made from or containing copolymers of propylene with ethylene and/or other alpha-olefins. In some embodiments, the high density ethylene polymers are selected from the group consisting of ethylene homopolymers and copolymers of ethylene with alpha-olefins, having 3-12 carbon atoms. In some embodiments, the linear low density polyethylene, the very low density polyethylene, and the ultra-low density polyethylene are copolymers of ethylene with one or more alpha-olefins having from 3 to 12 carbon atoms, having a mole content of units derived from the ethylene higher than 80%, based upon the total weight of the polyethylene.

In some embodiments, the polyolefins are obtained by polymerizing the relative monomers in the presence of a polymerization catalyst and using a platform technology. In some embodiments, the polymerization catalyst is a single-site catalyst or a heterogeneous ZN catalyst. In some embodiments, the platform technology is selected from the group consisting of liquid-phase polymerization, gas-phase polymerization, and hybrid liquid-/gas-phase polymerization

As used herein, the terms “recycled polyolefin material” and “recycled” refer to recovered material from either post-consumer waste (PCW) or post industrial waste (PIW), which includes a fraction made from or containing polyolefins.

In some embodiments, the recycled polyolefin material results from the sorting of the PCW or PIW aimed at selecting the polyolefin fraction.

In some embodiments, the sorting of polyolefin fraction is enhanced to provide a fraction of either polypropylene or polyethylene. In some embodiments, the recycled polyolefin material is made from or containing a mixture of polyethylene (PE) and polypropylene (PP) polymers in a weight ratio from 99:1 to 1:99. In some embodiments, the weight ratio of PP to PE is higher than 80/20, alternatively higher than 90/10, alternatively from 95/5 to 99:1. In some embodiments, the weight ratio of PE to PP is higher than 80/20, alternatively higher than 90/10, alternatively from 95/5 to 99:1. In some embodiments, the polyethylene (PE) fraction is made from or containing polyethylene selected from the group consisting of high density polyethylene (HDPE), low-density polyethylene (LDPE), and linear low density polyethylene (LLDPE). In some embodiments, the polypropylene fraction (PP) is selected from the group consisting of propylene homopolymer and a propylene copolymer with lower amount of ethylene, butene, or both. In some embodiments, the feedstock is further made from or containing other polyolefins like polybutene. In some embodiments, the feedstock is further made from or containing other polymers. In some embodiments, the other polymers are selected from the group consisting of polystyrene (PS), ethyl-vinyl acetate copolymer (EVA), ethyl-vinyl alcohol copolymer (EVOH), and polyvinyl chloride (PVC). In some embodiments, the recycled polyolefin material feedstock is made from or containing more than 80% wt, alternatively more than 90% wt, of a mixture between polyethylene and polypropylene.

In some embodiments, the final composition is defined by a recipe which identifies the nature of the virgin and recycled polyolefin fractions (the polymeric fraction), the nature of optional additives, reinforcing agents, or both, the number of components, the quantity of each component, and the respective ratios. In some embodiments, the constitution of the resulting polyolefin compositions differs from the constitution of other resulting polyolefin compositions. In some embodiments, the polymeric fraction of the final polyolefin compositions is made from or containing more than 50 wt % of polyolefin. In some embodiments, the final polyolefin compositions are made from or containing a polymeric fraction made from or containing from 80 to 99.98 wt. %, alternatively from 95 to 99.95 wt. %, alternatively from 98 to 99.9 wt. %, of a polyolefin portion.

In some embodiments, the final composition is made from or containing higher than 50% wt, alternatively higher than 60% wt, alternatively higher than 70% wt, of a polymeric fraction, and the remainder of a non-polymeric fraction. In some embodiments, the non-polymeric fraction is selected from the group consisting of additives, fillers, and reinforcing agents.

In some embodiments, a two-stage cascade extrusion process is a polymer processing procedure carried out operating two extruders in series, wherein the first extruder feeds the extrudate to the second extruder.

As used herein, the term “pelletized polyolefin composition” refers to the polyolefin composition obtained in form of pellets at the end of the two-stage extrusion process.

In some embodiments, the extruder devices are extruders or continuous mixers. In some embodiments, the extruders or mixers are single-or two-stage machines which melt and homogenize the polyethylene composition. In some embodiments, the extruders are selected from the group consisting of pin-type extruders, planetary extruders, and corotating disk processors. In some embodiments, the extruder devices are combinations of mixers with discharge screws and/or gear pumps. In some embodiments, the extruders are screw extruders, alternatively extruders constructed as twin-screw machine. In some embodiments, the extruder devices are selected from the group consisting of twin-screw extruders and continuous mixers with discharge elements. In some embodiments, the extruder devices are continuous mixers with counter rotating and intermeshing double screw. In some embodiments, the extruder device has at least one co-rotating double screw extruder. In some embodiments, the extruder device is commercially available from Coperion GmbH, Stuttgart, Germany; KraussMaffei Berstorff GmbH, Hannover, Germany; The Japan Steel Works LTD., Tokyo, Japan; Farrel Corporation, Ansonia, USA; or Kobe Steel, Ltd., Kobe, Japan. In some embodiments, the extruder devices are further equipped with units for pelletizing the melt, such as underwater pelletizers.

In some embodiments and in the first step (i), the recycled polyolefin material is fed in ground flakes or other free or non-free-flowing form. In some embodiments, the other form is fluff, film rolls, or other low bulk density form.

In some embodiments, the recycled polyolefin material in flakes is compacted and preheated before the recycled polyolefin material is fed to the extruder. In some embodiments, the flakes are compacted and preheated in a dedicated compactor with forced feeding.

The recycled polyolefin material is then molten in the first extrusion stage where also the degassing, humidity removal and contaminant removal is performed by melt filtration equipment.

In some embodiments, the design of melt filtration units varies, depending on the amount and particle size of the solid impurities.

In some embodiments, the melt filters are self-cleaning and operated for several days without manual intervention to replace filtration elements.

In some embodiments, the design of melt filter is based on a circular perforated plate as melt filtration element, with holes produced by laser, machining or other technology, where solid contaminants are accumulated. In some embodiments, accumulation of impurities increases differential pressure across the melt filter. In some embodiments and to perform a continuous cleaning of the filtration element, a rotating scraper removes the accumulated impurities and guides the impurities to a discharge port, which is opened to purge the contaminated material.

In some embodiments, the cleaning cycle is repeated several times (up to operation time of several days) without manual intervention or stopping production to replace the filtration element.

In some embodiments, the continuous melt filter uses continuous filtering metal bands through which the polymer flows. Impurities are accumulated on the metal filter, thereby generating an increase of pressure. In some embodiments, the clogged filtering band section is pushed out of the polymer passage area and a clean section is then automatically inserted.

In some embodiments, the continuous melt filters are referred to as Backflush Continuous Screen Changer. As contaminants build up on the screen pack, a pressure set point or a timer initiates the backflush operation in fully automated way, lifting and evacuating the impurities from screen surface before inserting the screen back in service.

In some embodiments, continuous melt filtration uses multiple screen pockets. During backflush or screen change, performed separately on the various pockets, part of the available filter area remains online. Each screen is self-cleaned in sequence according to contamination level and line pressure, until the backflush process fails to remove embedded contaminants effectively. Then, the screen pack is changed.

In some embodiments and in the second step (ii), the recycled molten polyolefin stream is then fed to the second stage extruder. In some embodiments, the second stage extruder is a twin screw extruder.

In some embodiments, the flow rate of the recycled molten polyolefin stream is unmetered.

In some embodiments, the second feeding inlet of the second-stage extruder for receiving the recycled molten polyolefin stream is located after the first feeding inlet for receiving virgin polyolefins. In some embodiments, the first feeding inlet for receiving the virgin polyolefins is the hopper.

In some embodiments and in step (iii), the virgin polyolefin is fed. In some embodiments, the virgin polyolefin is in a form selected from the group consisting of flakes, powder, and pellets. In some embodiments, the virgin polyolefin is fed in either powder or pelletized form. In some embodiments, the virgin polyolefin is fed in powder form. As used herein, the term “powder form” refers to polymer particles, having their particle size and particle size distribution directly deriving from the polymerization process, and are not yet pelletized.

In some embodiments, the polyolefin composition is further made from or containing one or more additives or reinforcing agents. In some embodiments, the additives or reinforcing agents are fed to the first extruder, the second extruder, or both. In some embodiments, anticorrosion additives are added to the first extruder, thereby preventing corrosion deriving from chemicals released by the recycled polyolefin material. In some embodiments, other additives, such as stabilizers or antioxidants, are fed to the second extruder.

In some embodiments, the virgin polymers and optionally additives are subject to melting and mixing in the first section of the second stage extruder before the entry point of the molten stream from the first stage extruder.

In some embodiments, the two melt streams are homogenized in the second stage extruder, optionally adding and incorporating reinforcing agents, and are then formed into pellets. In some embodiments, the pelletizing method is selected from the group consisting of underwater pelletization, water ring pelletization, and strand pelletization.

In some embodiments and in step (iv), the virgin polyolefin and optionally additives or reinforcing agents are supplied to a metering device before being transferred to the second extruder device for melting and further mixing. In some embodiments, the transfer occurs by gravity.

In some embodiments, the virgin polyolefin and optionally additives or reinforcing agents are fed by using dedicated continuous metering devices associated to the mixing device. In some embodiments, the continuous metering devices are loss in weight feeders or mass flow meters.

In some embodiments, the relative ratio between recycled polyolefin, virgin polyolefin, and optional additives or reinforcing agents, in the final polyolefin composition as provided for in the preset formulation composition is achieved by adjusting the flow rates of virgin polymer, the additives, or the reinforcing agents based on the metered amount of pelletized final polyolefin composition. In some embodiments, the computing unit determines the difference between the metered amount of final polyolefin composition and the metered flow of virgin polyolefin and optional additives or reinforcing agents. This difference corresponds to the unmetered flow of recycled polyolefin. Based on this calculated flow of recycled polyolefin, the computing unit, via a controller, adjusts the flow of the virgin polyolefin powder feeding device and additives or reinforcing agent feeding device, thereby meeting the set points for virgin polymers and additives or reinforcing agents, which that were predetermined based on the pre-set compositional parameters of the final polyolefin composition.

In some embodiments, the recycled material and the virgin polymer material is subject to a single melting and pelletization stage.

In some embodiments, the flow rate of the polyolefin pellets of the final composition is measured on dried polyolefin pellets via a pellet flow meter. In some embodiments, the flow rate of the polyolefin pellets of the final composition is measured downstream of an underwater pelletizer and centrifugal drier. In some embodiments, the flow rates of optional additives or reinforcing agents are adjusted based on the amount of polyolefin pellets produced in the second extruder device. In some embodiments, the flow rates of optional additives or reinforcing agents are adjusted, using different control characteristics and equipment for controlling the flow rates of the optionally supplied additives and reinforcing agents and for controlling the feed of polyolefin powder.

In some embodiments, the flow rate of the polyolefin pellets produced in the second extruder device is continuously or discontinuously measured to determine the total production rate. In some embodiments, the pellet flow is measured by a pellet flow meter. In some embodiments, the pellet flow meters use impact plate, measuring chute or Coriolis measuring technologies. In some embodiments, the solids flow meters are commercially available, from Schenck Process, Whitewater, WI, USA or Coperion K-Tron, Gelnhausen, Germany.

In some embodiments, the devices are weighed movable belts. In some embodiments, the discontinuous measure of pellet flow is obtained by measuring the weight increase in the pellet collection bin.

In some embodiments, the pellet flow meter is equipped with a controller. In some embodiments, this controller, operated by the computing unit, adjusts the speed of the feeding device, which supplies the virgin polyolefin and the additive or reinforcing agent to the extruder, based on the preset formulation recipe.

In some embodiments and to modify the recycled polyolefin melt flow rate, the same feeding, metering and controlling system is operated by the same computing unit which adjusts the feed rate of the peroxide (or equivalent visbreaking agent) to the first extruder.

In some embodiments, the peroxide feeding device supplies the peroxide to the extruder feed point where the recycled polyolefin is fed.

In some embodiments, a melt flow rate measuring device is associated to the outlet of the first stage extruder. In some embodiments, this device measures the melt flow rate in-line, wherein the resulting values are inputs for the computing unit. In some embodiments and based on the difference between preset and measured melt flow rate values of the recycled polyolefin material, the computing unit, via the controller, operates the peroxide feeding device by adjusting the feeding rate, thereby aligning the measured melt flow rate value with the preset melt flow rate.

In some embodiments, the computing unit is a programmable computing controller (PLC) adapted for the control of manufacturing processes.

In some embodiments, the computing unit operates in cooperation with local controllers which send the data received from the metering devices to the computing unit and directly control the feeding devices based on the output received from the computing unit.

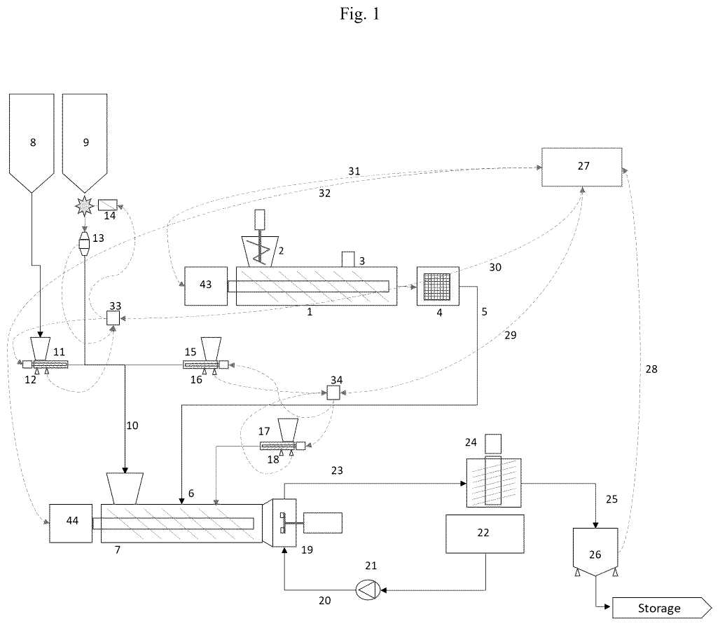

With reference to FIG. 1, recycled polyolefin is supplied to the hopper (2) of the first stage extruder (1), provided with vacuum degassing for humidity removal (3) and a melt filter section (4). The molten stream is supplied via line (5) to the entry point (6) of the second stage extruder (7). Virgin polymer in silos (8, 9) is fed to the second stage extruder (7) via line (10), which receives the polymer either by feeding device (11) equipped with loss in weight metering device (12) or by the feeding device (14) equipped with the mass flow meter metering device (13). In some embodiments, additives and reinforcing agents are supplied via feeding devices (15, 17), provided with metering devices (16, 18). The second stage extruder (7) is associated to a slurry underwater pelletizer (19), which is supplied with water via line (20), water recirculation pump (21), and water tank (22). The pellets exiting the pelletizer are conveyed via line (23) to a spin drier (24). Dry pellets are then fed via line (25) to a pellet metering device (26) and further to a storage vessel (not shown).

The computing unit (27) receives input data (28) from the pellet metering device (26) and, via controllers (33, 34), from the metering devices (12, 14 16, 18) of feeding devices (11, 13, 15 and 17). The computing unit (27) sends output data (29, 30, 31, 32), via controllers (33, 34), to the feeding devices (11, 13, 15, 17), thereby adjusting feeding rate, and to first stage extruder motor (1) and to second stage extruder motor (2), thereby adjusting total flow rate in view of metered total flow rate.

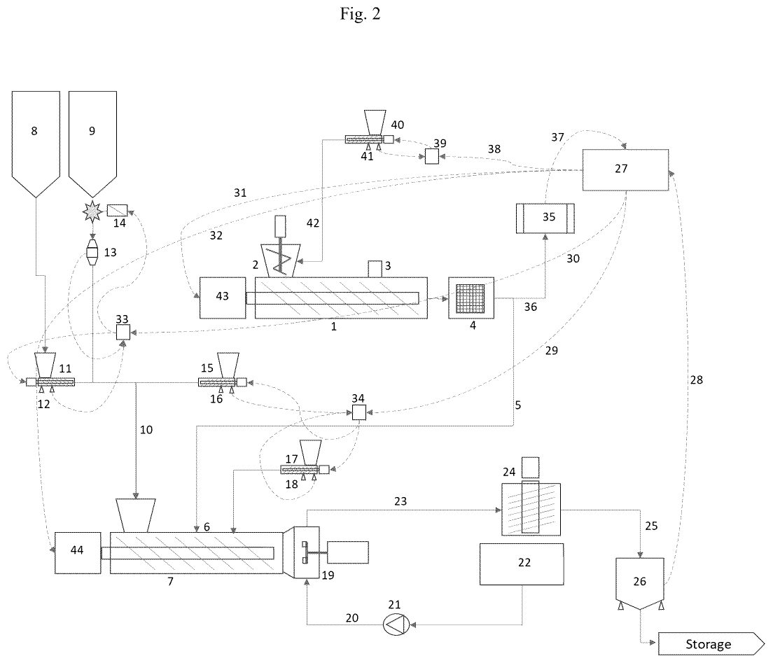

With reference to FIG. 2, the in-line MFR measuring device (35), positioned on line (36), provides an input (37) to the computing unit (27), which sends output (38) to control (39), thereby adjusting the speed of the feeding device (40) equipped with metering devices 41, supplying, via line 42, peroxide to the hopper (2).

What is claimed is:

1. A process for preparing a pelletized polyolefin composition comprising a virgin polyolefin and a recycled polyolefin material, having pre-set relative content, carried out in a two-stage cascade extrusion process, of which the second-stage extruder has a first feeding inlet and a second feeding inlet, comprising the following steps:
(i) supplying the recycled polyolefin material to the first-stage extruder, thereby forming a molten recycled polyolefin material stream;
(ii) feeding the molten recycled polyolefin material stream to the second feeding inlet of the second-stage extruder, located after the first feeding inlet for receiving the virgin polyolefin;
(iii) feeding virgin polyolefin at a flow rate to the first feeding inlet of the second-stage extruder device, thereby forming a polyolefin composition, and extruding the polyolefin composition in a pelletized form;
(iv) measuring the flow rate of the virgin polyolefin supplied to the second stage extruder device and measuring the flow rate of the pellets of the final polyolefin composition obtained from the second extruder device;
wherein a computing unit operation device, receiving data on measured flow of virgin polymer and measured flow rate of pelletized final polymer composition, adjusts the flow rate of the virgin polyolefin supplied to the second-stage extruder in response to the difference between the measured flow rate of the virgin polyolefin and the measured flow of pelletized final polymer composition, thereby producing a final pelletized polyolefin composition having the pre-set relative content of virgin polyolefin and recycled polyolefin material.

2. The process according to claim 1, wherein the virgin polyolefin is derived from polymerization of olefins.

3. The process according to claim 1, wherein the recycled polyolefin material comprises a mixture of polyethylene (PE) and polypropylene (PP) polymers in a weight ratio from 99:1 to 1:99.

4. The process according to claim 1, wherein the polyolefin composition further comprises additives and, optionally, reinforcing agents.

5. The process according to claim 1, wherein the polyolefin composition comprises from 80 to 99.98 wt. % of a polyolefin portion.

6. The process according to claim 1, wherein the recycled polyolefin material in flakes is compacted and preheated before being fed to the extruder.

7. The process according to claim 1, wherein, in the first extrusion stage, the molten recycled polymer material is subject to degassing, humidity removal and contaminant removal by melt filtration equipment.

8. The process according to claim 1, wherein the second feeding inlet of the second-stage extruder for receiving the recycled molten polyolefin stream is located after the first feeding inlet for receiving virgin polyolefins.

9. The process according to claim 1, wherein the virgin polyolefin is fed in either powder or pelletized form.

10. The process according to claim 1, wherein in step (iv), the virgin polyolefin and optionally additives or reinforcing agents are fed by using dedicated continuous metering devices associated to the mixing device.

11. The process according to claim 10, wherein the metering devices are loss in weight feeders or mass flow meters.

12. The process according to claim 1, wherein the relative ratio between recycled polyolefin, virgin polyolefin, and optional additives or reinforcing agents, in the final polyolefin composition as provided for in the pre-set formulation composition is achieved by adjusting the flow rates of virgin polymer, the additives, or the reinforcing agents based on the metered amount of pelletized final polyolefin composition.

13. The process according to claim 12, wherein the computing unit determines the difference between the metered amount of final polyolefin composition, and the metered flow of virgin polyolefin and optional additives or reinforcing agents.

14. The process according to claim 13, wherein the computing unit, via a controller, adjusts the flow of the virgin polyolefin feeding device and additives or reinforcing agent feeding device, thereby meeting the predetermined set points for virgin polymers and additives or reinforcing agent.

15. The process according to claim 1, wherein the flow rate of the polyolefin pellets of the final composition is measured on dried polyolefin pellets via a pellet flow meter.
